(19) United States
(12) Patent Application Publication
(10) Pub. No.: US 2006/0045121 A1
(43) Pub. Date: Mar. 2, 2006

(54) Methods and systems for analyzing network transmission events

(76) Inventor: John M. Monk, Monument, CO (US)

Correspondence Address: AGILENT TECHNOLOGIES, INC.;Legal Department, DL 429, Intellectual Property Aministration, P.O. Box 7599, Loveland, CO, 80537-0599, US

(21) Appl. No.: 10/925,603

(22) Filed: Aug. 25, 2004

(51) Int. Cl. H04J 3/22

(52) U.S. Cl. 370/461

(57) ABSTRACT

Methods and system for analyzing a number of data streams collected at an arbitrary point in a network. In an embodiment of the method of this invention, one or more transmission messages are acquired, the transmission messages being transmitted over a network according to a predetermined protocol. The one or more acquired transmission messages are provided to a state machine.

### BACKGROUND OF THE INVENTION

This invention relates generally to monitoring network transmission.

In many applications (for example, VoIP applications) devices can exchange, over a network, many transmission messages with other devices. The need for analyzing large amounts of data collected from these transmission messages can be best described by reference to the following particular application.

A real-time protocol (RTP) provides end-to-end network transport functions suitable for applications transmitting real-time data, such as audio, video or simulation data, over multicast or unicast network services. RTP does not address resource reservation and does not guarantee quality-of-service for real-time services. RTP is designed to be independent of underlying transport and network layers. One of the problems involved in determining the worst-case RTP streams is that of available processing power to examine and analyze every RTP stream transmitted between endpoints. For instance, at the arbitrary point within the network, thousands of RTP streams pass through, thus, analyzing each RTP stream that passes through the arbitrary point cannot be done by existing processing technology.

While the above discussion refers to an RTP streams, the same situation occurs with many streams of data transmitted utilizing other protocols.

There is a need for methods and systems that allow analyzing the number of data streams collected at any arbitrary point in the network.

### BRIEF SUMMARY OF THE INVENTION

The needs for the invention set forth above as well as further and other needs and advantages of the present invention are achieved by the embodiments of the invention described hereinbelow.

Methods and system for analyzing a number of data streams collected at an arbitrary point in a network are presented.

In an embodiment of the method of this invention, one or more transmission messages are acquired, the transmission messages being transmitted over a network according to a predetermined protocol. The one or more acquired transmission messages are provided to a state machine. Utilizing the state machine, an expected behavior (in one embodiment, an expected state) for the one or more acquired transmission messages is obtained. Each of the one or more acquired transmission messages is compared to the expected behavior and a notification is provided if the comparison indicates departure from the expected behavior.

Systems that implement the methods of this invention and computer program products utilized in practicing the method are also disclosed.

For a better understanding of the present invention, together with other and further objects thereof, reference is made to the accompanying drawings and detailed description and its scope will be pointed out in the appended claims.

### BRIEF DESCRIPTION OF THE DRAWINGS

FIG. 1 is a schematic flowchart description of an embodiment of the method of this invention;

FIG. 2 is a schematic block diagram description of an embodiment of the system of this invention;

FIG. 3 is a schematic pictorial description of a network utilizing systems of this invention;

FIG. 4 is a schematic block diagram description of another embodiment of the system of this invention;

FIG. 5 is a schematic block diagram description of a conventional protocol state machine; and,

FIG. 6 is a schematic block diagram description of another conventional protocol state machine.

### DETAILED DESCRIPTION OF THE PREFERRED EMBODIMENTS

Methods and system for analyzing a number of data streams collected at an arbitrary point in a network are disclosed hereinbelow.

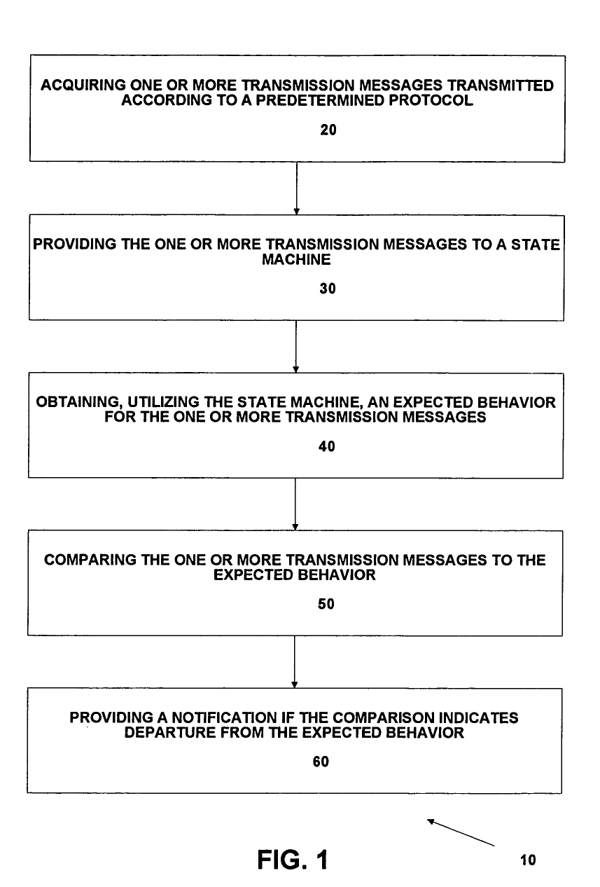

A flowchart description of an embodiment of the method of this invention is shown in FIG. 1. Referring to FIG. 1, in the embodiment 10 of the method of this invention, one or more transmission messages (also referred to as data streams), transmitted according to a predetermined protocol, are acquired (step 20, FIG. 1) and the one or more acquired transmission messages are provided to a state machine (step 30, FIG. 1). Utilizing the state machine, an expected behavior (in one embodiment, an expected state) for the one or more acquired transmission messages is obtained (step 40, FIG. 1). Each of the one or more acquired transmission message is compared to the corresponding expected behavior (step 50, FIG. 1) and a notification is provided if the comparison indicates departure from the expected behavior (step 60, FIG. 1). In some embodiments, several transmission messages are acquired and are processed (through steps 30 to step 60) in parallel.

In one embodiment the system of this invention includes an acquisition subsystem capable of acquiring one or more messages transmitted over a network, the messages being transmitted according to a predetermined protocol, and means for instantiating a state machine, the state machine including:
means for iterating over a number of data messages,
means for providing one data message to an analysis process,
analysis process means for obtaining an expected state for the data message provided to the analysis process, means for comparing the behavior at the expected state to the behavior of the data message, and,
means for notifying a difference between the expected state and the data message. In this embodiment, the system of this invention also includes means for providing the one or more acquired messages to the state machine and an output subsystem capable of providing notification of the differences between the one or more acquired messages and expected states corresponding to the one or more acquired messages. (Instantiating is used herein in a manner similar to that in which instantiating is used in object oriented computer languages. The means for instantiating are comprised of software or dedicated hardware or hardware/software that results in an instantiation of the state machine for a predetermined protocol.)

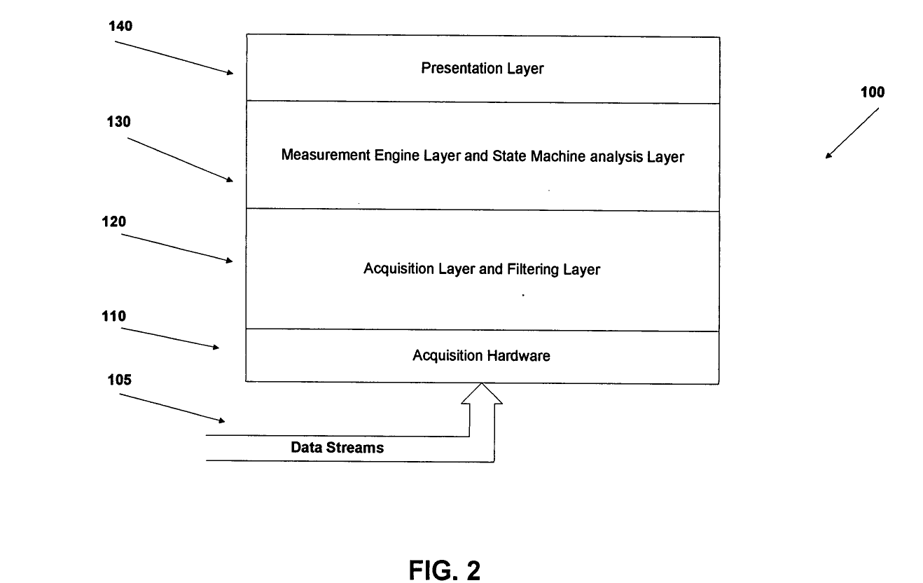

The schematic representation shown in FIG. 2 depicts an embodiment 100 of the system of this invention utilizing a layer representation (similar to that used to depict protocols). Referring to FIG. 2, the embodiment 100 of the system of this invention acquires the data from a transmission message (data stream) 105 by means of the acquisition hardware 110 (the acquisition hardware can be similar, but is not limited to, to that found in network analyzers such as the “J6800A Network Analyzer” of AGILENT TECHNOLOGIES, Inc.). The acquisition layer and Filtering layer receive the data from one or more transmission messages 105 and renders the data in a form that can be provided to the state machine analysis layer 130. The acquisition layer and Filtering layer constitute means for providing the data from one or more transmission messages 105 to the state machine. (In one embodiment, the acquisition layer and Filtering layer comprise software that instructs a processor to parse the received messages and provides the data to the state machine. The same function can be implemented, in another embodiment, in dedicated hardware or dedicated hardware/software.) The data is analyzed by means of the state machine and differences between the data from one or more transmission messages 105 and expected states corresponding to the one or more transmission messages 105 are notified to the presentation layer 140. The presentation layer 140 provides the notification of the differences and, in one embodiment, comprises the software component of the output sub-system.

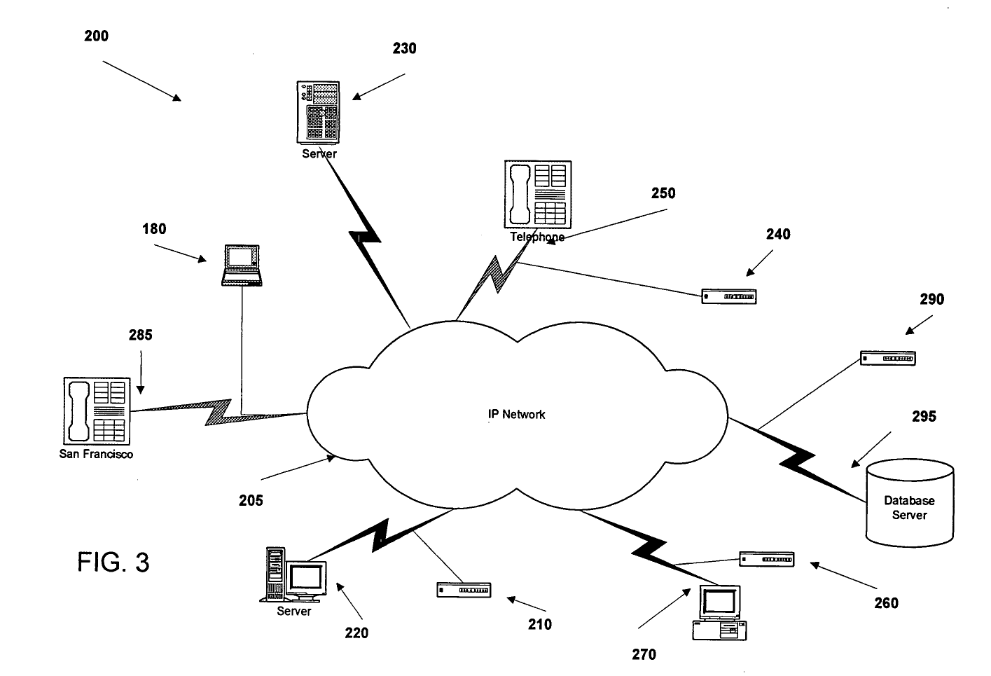

A network 200 utilizing embodiments of the network monitoring system of this invention is shown in FIG. 3. Referring to FIG. 3, the network 200, utilizing an embodiment of the network monitoring system of this invention, includes a network monitoring system (device) 210 capable of monitoring network transmission messages at a network location 220, a server 230, and a number of other network monitoring devices 240, 260, 280, 290 at a number of other network locations 250, 270, 285, 295.

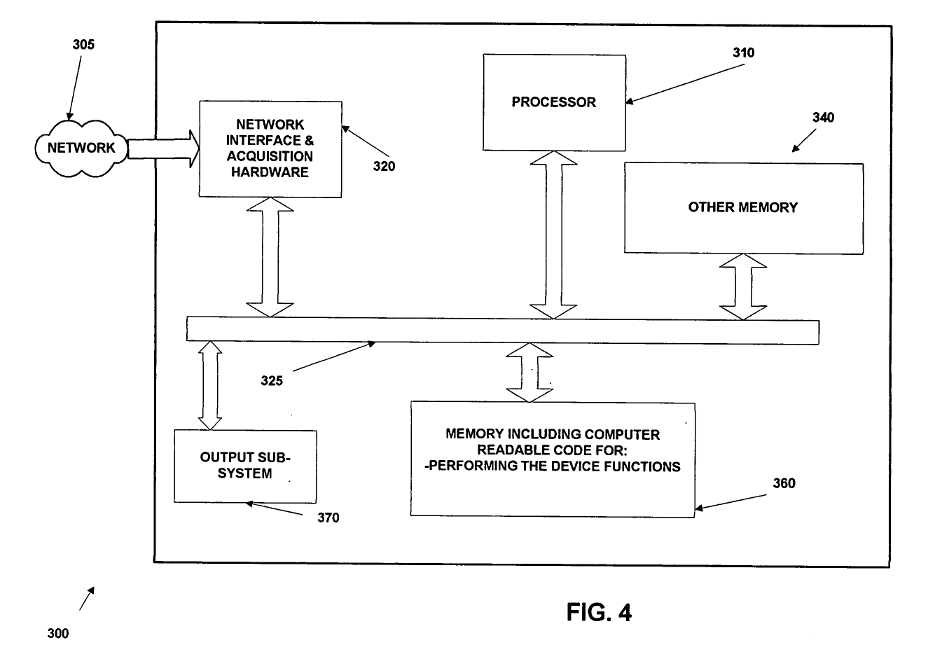

In one embodiment, the system of this invention is based on an implementation such as, but not limited to, that shown in FIG. 4, where the system includes a network interface/data acquisition component 320, one or more processors 310, one or more computer readable memories 360, at least one other computer readable memory 340 and an output sub-system 370. The network interface component 320, the one or more processors 310, the one or more computer readable memories 360, the output sub-system 370 and the other one or more computer readable memories 340 are operably connected by means of a interconnection means 325 (such as, but not limited to, a common “bus”).

The output sub-system can include, but is not limited to, storage means (such as any computer readable medium) for storing the notifications, display for displaying the notifications or processed results from the notifications, or means for transmitting the results over a network to a central server (utilizing the network interface component).

The one or more computer readable memories 360 have computer readable code embodied therein, the computer readable code being capable of causing the one or more processors 310 to:
provide an instantiation of a state machine for transmission over a network utilizing a predetermined protocol,
initialize the state machine,
provide one or more acquired transmission messages to the state machine,
obtain, utilizing the state machine, an expected behavior for the one or more acquired transmission messages,
compare the one or more acquired transmission messages to the expected behavior, utilizing the state machine, provide a notification, utilizing the state machine, if the comparison indicates departure from the expected behavior, and reset the state machine.

An embodiment of pseudocode for the state machine of this invention is given below.

StateMachine::begin( ) {
Iterate over individual data streams observed by the
acquisition hardware and process them in parallel
}
StateMachine::processMessage(newMessage,
messageProcessObject) {
Give the message to a process objects and delegate the
evaluation work to the process object
}
messageProcessObject::evaluate(newMessage) {
Compare the new message with the expected message
If it is expected, move to the next state, otherwise
notify that an error has been observed
}
StateEvaluation::run( ) {
While in a non complete state
Compare collected messages against what is expected
Stay in the current state or move to a new state or
trigger or clear counts and reset state
}
StateMachine::incorrectStateObserved( ) {
Perform desired notification action
}

In order to even more clearly understand the present invention, reference is now made to the following illustrative embodiment. Referring again to FIG. 3, a calling telephone 285 (i.e., source) initiates a phone call to a receiving telephone 250 (i.e., receiver) over a network 205. In the embodiment shown in FIG. 3, the network is an Internet Protocol network. In one embodiment, the phone call initiation occurs via signaling messages (signaling transmission events) utilizing SIP as the signaling protocol. A number of signaling messages are observed and collected at any of the network monitoring devices 210, 240, 260, 280, 290. At one of the network monitoring devices 210, 240, 260, 280, 290, data from a number of signaling (transmission) messages (data stream) (105, FIG. 2) is acquired by means of the acquisition hardware (110, FIG. 2). The one or more acquired signaling (transmission) messages are provided to the state machine.

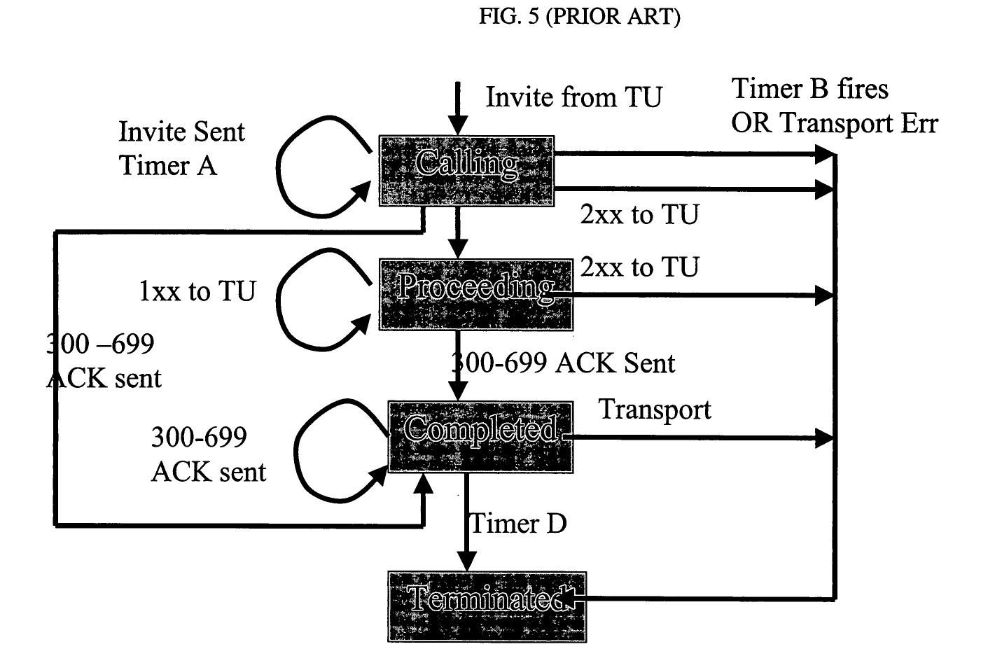

The state machine has several states in which state change is invoked by an event. The event may result in different states, depending on the current state. The state machine iterates over individual data streams (messages) acquired by the acquisition hardware and processes the data streams in parallel. After initializing the state machine as to the protocol being analyzed, resetting the state machine and providing an initial state, one messages in each parallel processing thread is to provide to process state evolution. Both client and server transactions in SIP are obtained from finite state machines. (The client sends the request and the server provides the response. See RFC3261, “SIP: Session Initiation Protocol”, June 2002, available at http://www.ietf.org/rfc/rfc3261.txt, which is herein incorporated by reference, p. 122.) The appropriate SIP finite state machines can be include in the state evaluation function. For example, the conventional finite state machine for the INVITE client transaction is shown in FIG. 5. (The state machine shown in FIG. 5 is described in RFC3261, p. 127 and shown in “Testing SIP using XML Templates”, available at http://www.testcom2003.org/Presentations/Session1/3_Testing % 20SIP.ppt. It should be noted that this conventional finite state machine is one of many state machines that describes SIP. Hereinafter, a protocol state machine is also referred to as a process.) While in any of the states before completion of the operation of the process, messages are compared against what is expected according to protocol state machine (process) evolution. If the message behavior is according to the expected behavior, the state machine moves to the next state; otherwise, the state machine notifies that an error has been observed. This process occurs in parallel for each acquired message.

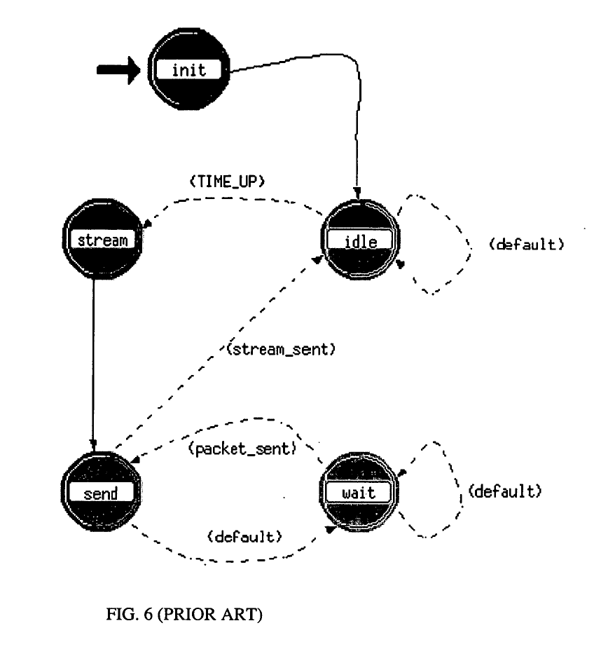

Protocol state machines can be obtained for a variety of other protocols, such as, but not limited to, RTP (a real time transport protocol). A conventional generalized protocol state machine (process) is shown in FIG. 6 (described in Lecture 13, CE64183, Winter 2004, University of Ottawa, available at http://www.discover.uottawa.ca/˜shervin/ceg4183/lectures/Lecture13.pdf). Once the state machine has been initialized to the protocol being analyzed, utilizing the protocol process (protocol state machine), the network monitoring device can analyze the transmission message utilizing the methods and system described above.

It should be noted that although the present invention has been described above in terms of the SIP and RTP protocols, the present invention is not limited to these protocols. Other protocols, other than stateless protocols, can be similarly analyzed by means of the methods and systems of this invention.

Furthermore, the exemplary network 200 in FIG. 3 is simplified for ease of explanation. The network 200 may include more or fewer additional elements such as networks, communication links, proxies, firewalls or other security mechanisms, Internet Service Providers (ISPs), MCUs, gatekeepers, gateways, and other elements.

In general, the techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to data entered using the input device to perform the functions described and to generate output information. The output information may be applied to one or more output devices.

Elements and components described herein may be further divided into additional components or joined together to form fewer components for performing the same functions.

Each computer program (code) within the scope of the claims below may be implemented in any programming language, such as assembly language, machine language, a high-level procedural programming language, or an object-oriented programming language. The programming language may be a compiled or interpreted programming language.

Each computer program may be implemented in a computer program product tangibly embodied in a computer-readable storage device for execution by a computer processor. Method steps of the invention may be performed by a computer processor executing a program tangibly embodied on a computer-readable medium to perform functions of the invention by operating on input and generating output.

Common forms of computer-readable or usable media include, for example, a floppy disk, a flexible disk, hard disk, magnetic tape, or any other magnetic medium, a CDROM, any other optical medium, punched cards, paper tape, any other physical medium with patterns of holes, a RAM, a PROM, and EPROM, a FLASH-EPROM, any other memory chip or cartridge, a carrier wave, or any other medium from which a computer can read.

Although the invention has been described with respect to various embodiments, it should be realized this invention is also capable of a wide variety of further and other embodiments within the spirit and scope of the appended claims.

What is claimed is:

1. A method for analyzing data transmission, the method comprising the steps of:
acquiring at least one transmission message, the transmission message been transmitted over a network according to a predetermined protocol;
providing the at least one acquired transmission message to a state machine;
obtaining, utilizing the state machine, an expected behavior for the at least one acquired transmission message;
comparing the at least one acquired transmission message to the expected behavior;
providing a notification if the comparison indicates departure from the expected behavior.

2. The method of claim 1 wherein the step of obtaining an expected behavior comprises the step of determining an expected state; and
wherein the step of comparing the at least one acquired transmission message to the expected behavior comprises the step of comparing the behavior at the expected state to the at least one acquired transmission message.

3. The method of claim 1 wherein the network comprises an Internet Protocol network.

4. The method of claim 1 wherein the predetermined protocol comprises a signaling protocol.

5. The method of claim 4 wherein the signaling protocol is a session initiation protocol (SIP).

6. The method of claim 1 wherein the predetermined protocol comprises a real time transport protocol.

7. A system comprising:
an acquisition subsystem capable of acquiring at least one message transmitted over a network, said at least one message being transmitted according to a predetermined protocol;
means for instantiating a state machine, said state machine comprising:
means for iterating over a plurality of data messages;
means for providing one data message from the plurality of data messages to an analysis process;
analysis process means for obtaining an expected state for said one data message;
means for comparing said expected state to said one data message; and
means for notifying a difference between said at expected state and said one data message;
means for providing said at least one acquired message to said state machine; and
an output subsystem capable of providing notification of the differences between said at least one acquired message and expected states corresponding to said at least one acquired message.

8. The system of claim 7 wherein said at least one acquired message comprises a plurality of acquired messages; and
wherein said state machine further comprises means for repeatedly providing each one of the plurality of data messages to said analysis process for processing in parallel.

9. The system of claim 7 wherein the network comprises an Internet Protocol network.

10. The system of claim 7 wherein the predetermined protocol comprises a signaling protocol.

11. The system of claim 10 wherein the signaling protocol is a session initiation protocol (SIP).

12. The system of claim 7 wherein the predetermined protocol comprises a real time transport protocol.

13. A computer program product comprising:
at least one computer usable medium having computer readable code embodied therein, the computer readable code capable of causing at least one processor to:
instantiate a state machine for transmission over a network utilizing a predetermined protocol, said state machine comprising:
means for providing at least one data message to an analysis process;
analysis process means for obtaining an expected state for said one data message;
means for comparing said expected state to said at least one data message; and
means for notifying a difference between said at expected state and said at least one data message;
initialize said state machine;
provide at least one acquired transmission message to said state machine;
obtain, utilizing said state machine, an expected behavior for said at least one acquired transmission message;
compare said at least one acquired transmission message to the expected behavior, utilizing said state machine;
provide a notification, utilizing said state machine, if the comparison indicates departure from the expected behavior; and
reset said state machine.

14. The computer program product of claim 13 wherein said at least one acquired transmission message comprises a plurality of acquired transmission messages;
where in said state machine said at least one data message comprises a plurality of data messages; and
wherein said state machine further comprises:
means for iterating over said plurality of data messages.

15. The computer program product of claim 13 wherein the network comprises an Internet Protocol network.

16. The computer program product of claim 13 wherein said predetermined protocol comprises a signaling protocol.

17. The computer program product of claim 13 wherein the signaling protocol is a session initiation protocol (SIP).

18. The computer program product of claim 13 wherein said predetermined protocol comprises a real time transport protocol.
